(19) United States
(12) Patent Application Publication
(10) Pub. No.: US 2025/0265530 A1
(43) Pub. Date: Aug. 21, 2025

(54) INFORMATION PROCESSING DEVICE, INFORMATION PROCESSING METHOD, AND INFORMATION PROCESSING SYSTEM

(71) Applicant: Toshiba Tec Kabushiki Kaisha, Tokyo (JP)

(72) Inventors: Hideaki FUKAYA, Sunto Shizuoka (JP); Kazuhiro KAMIMURA, Mishima Shizuoka (JP); Yusuke ERA, Sunto Shizuoka (JP)

(73) Assignee: Toshiba Tec Kabushiki Kaisha, Tokyo (JP)

(21) Appl. No.: 19/054,305

(22) Filed: Feb. 14, 2025

(30) Foreign Application Priority Data
Feb. 16, 2024 (JP) 2024-021890

(51) Int. Cl. G06Q 10/0639

(52) U.S. Cl. CPC G06Q 10/06398

(57) ABSTRACT

An information processing device, system, and method are described herein. The information processing device acquires an experience value of a user and determines a skill level of the user based on the experience value. The skill level of the user is either skilled or unskilled. The information processing device extracts support candidates based on experience values of other users in response to determining that the skill level of the user is unskilled and outputs information regarding the support candidates. The information processing device further causes a display device to display information regarding the skill level of the user, and/or the support candidates.

### CROSS-REFERENCE TO RELATED PATENT APPLICATIONS

This application is based upon and claims the benefit of priority from Japanese Patent Application No. 2024-021890, filed on Feb. 16, 2024, the entire contents of which are incorporated herein by reference.

### TECHNICAL FIELD

Embodiments described herein relate generally to an information processing device, an information processing method, and an information processing system.

### BACKGROUND

Workflow systems that circulate document data such as various application forms for approval and settlement in organizations such as companies are known. In a workflow system, for example, when an application form is generated, a drafter inputs necessary information and attaches evidence such as certificates required for the application. When the drafter completes the work, document data is circulated to a checker, an approver, and the like in accordance with a circulation route.

In workflow systems of the related art, a method of using a workflow may be personalized for each organization, and inexperienced people or unskilled people with less experience cannot understand how to use the workflow, which may lead to poor work efficiency. Consequently, there is a demand for a work support system that introduces experienced users to unexperienced or unskilled people who use workflows, improving work efficiency.

### BRIEF DESCRIPTION OF THE DRAWINGS

FIG. 1 is a block diagram illustrating a work support system according to an embodiment;

FIG. 2 is a sequence diagram showing an example of a procedure of information processing performed by the work support system;

FIG. 3 is a flowchart showing an example of a procedure of information processing related to skill level determination performed by a server according to the embodiment; and

FIG. 4 is a flowchart showing an example of a procedure of information processing related to inquiry processing performed by the server.

### DETAILED DESCRIPTION

The problem to be solved by the embodiments is to provide an information processing device, an information processing method, and an information processing system which are capable of improving the work efficiency of an unskilled person.

The information processing device described herein acquires an experience value of a user and determines a skill level of the user based on the experience value. The skill level of the user is either skilled or unskilled. The information processing device extracts support candidates based on experience values of other users in response to determining that the skill level of the user is unskilled and outputs information regarding the support candidates. The information processing device further causes a display device to display information regarding the skill level of the user, and/or the support candidates.

In some examples, the information processing device includes an acquisition unit, a determination unit, an inquiry processing unit, and a communication processing unit. The acquisition unit acquires an experience value of a user. The determination unit determines a skill level of the user based on the experience value. The inquiry processing unit extracts support candidates based on experience values of other users when the skill level of the user is unskilled. The communication processing unit outputs information regarding the support candidates.

An embodiment will be described below with reference to the drawings. In the drawings, the same components are given the same reference numerals as much as possible, and repeated descriptions will be omitted.

### Configuration Example

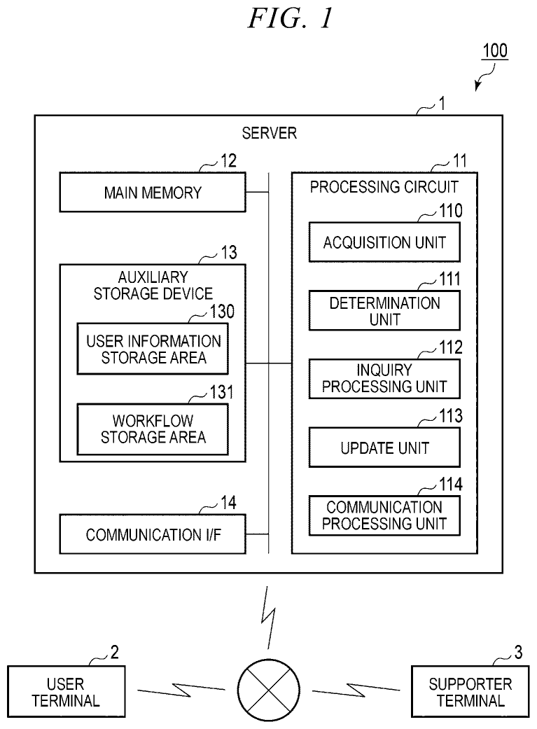

FIG. 1 is a block diagram illustrating a work support system 100 according to an embodiment. The work support system 100 includes a server 1, a user terminal 2, and a supporter terminal 3. The server 1, the user terminal 2, and the supporter terminal 3 are communicatively connected to each other via a network. For example, the network is configured with one or more networks among various networks such as the Internet, a mobile communication network, and a local area network (LAN). The one or more networks may include a wireless network or a wired network. The work support system 100 may also refer to a system including at least two apparatuses among the server 1, the user terminal 2, and the supporter terminal 3.

The server 1 is a device that collects data and processes the collected data (e.g., a controller). The server 1 is communicatively connected to the user terminal 2 and the supporter terminal 3 via the network. The server 1 receives various data from the user terminal 2 and the supporter terminal 3, and outputs various data to the user terminal 2 and the supporter terminal 3. The server 1 is an example of an information processing device. An example of the configuration of the server 1 will be described later. The server 1 may be a server used in a cloud service.

The server 1 provides a workflow service for performing processes from generation of an application form or the like to approval or settlement. The workflow service provides, for example, a workflow for generating and managing document data. The workflow includes a series of work in which a drafter generates document data and circulates the document data to a worker of the succeeding order in accordance with a predetermined circulation route. The generation of the document data includes inputting necessary information, attaching necessary documents, and the like. The circulation includes notifying the worker of the succeeding order. The worker of the succeeding order confirms the document data generated by the drafter. The worker of the succeeding order may include a checker, an approver, and the like. The workflow service may include a plurality of workflows. A workflow is, for example, set for each operation that can be viewed or worked on by a plurality of workers within an organization. The organization may include workers who perform work from the start to the completion of a workflow. The organization may be, for example, a company, a business, or an office. The organization is not limited to those mentioned above and may be a community that includes a plurality of workers. A workflow may include, for example, a series of tasks such as drafting, approval, and settlement. The workflow may include, for example, the generation of various forms for travel expense applications or facility use applications. In some examples, the workflow may include generation of a report or generation of a written request. The workflow may include information sharing within an organization. The workflow may be set for each operation, task, or topic.

The server 1 provides an inquiry service for inquiring a supporter for a workflow (e.g., for requesting support). The inquiry service may be a service included in the workflow service. The inquiry service may be a service separate from the workflow service. The inquiry service is, for example, a service for inquiring/requesting a supporter for each workflow and providing information regarding the supporter to a worker. The supporter is a person who supports the work of the worker. The support includes actions for making the work of the worker more efficient. The support includes, for example, receiving a question from the worker and providing an answer. The support includes solving the worker's doubt (e.g., addressing a worker's concerns, providing guidance, etc.). The support includes helping the worker with his or her work. The support includes support related to a workflow, support related to the use of the workflow service, and the like. The supporter is also referred to as a consultant. The supporter may be selected from among skilled people for the workflow. The skilled people may be, for example, workers, checkers, or approvers who have a lot of experience working on the workflow. The skilled people may be workers, checkers, or approvers who have a lot of knowledge about the workflow. The skilled people are workers, checkers, or approvers whose experience value for each workflow is equal to or greater than a predetermined threshold value. The experience value may be calculated based on a work history. The work history includes, for example, the number of tasks a worker has completed and a working time (e.g., employment duration, amount of time in a particular role, etc.). The experience value may be calculated based on a support history. The support history includes, for example, the number of times a worker has performed support tasks, a period of time for which support is performed, and a working time of a person being supported.

The server 1 selects a support candidate from a group of skilled people and provides the worker with information regarding the support candidate. The support candidate is a candidate for a supporter (e.g., a candidate who may serve as a supporter for a particular drafter, applicant, or worker). The support candidate may be the same person as a checker or an approver, or may be a different person. A person to be supported is a drafter, an applicant, or a worker. The person to be supported is an example of a user of the user terminal 2.

The user terminal 2 is an apparatus that can communicate with other electronic apparatuses. The user terminal 2 is an apparatus used by a drafter of a workflow (e.g., a personal computer (PC), a smartphone, a tablet terminal, or the like, but is not limited thereto). The user of the user terminal 2 uses a workflow service and an inquiry service via the user terminal 2. The user of the user terminal 2 may be read as a drafter, an applicant, a worker, or a person.

The supporter terminal 3 is an apparatus that can communicate with other electronic apparatuses. The supporter terminal 3 is an apparatus used by a supporter. The supporter terminal 3 may be a user device (e.g., a PC, a smartphone, a tablet terminal, or the like). The user of the supporter terminal 3 may include a supporter, a support candidate, a skilled person, a checker, an approver, or another person associated with the organization.

An example of the configuration of the server 1 will be described more fully below. The server 1 is an apparatus that includes a processing circuit 11, a main memory 12, an auxiliary storage device 13, and a communication interface 14. Parts that configure the server 1 are connected to each other (e.g., by wired or wireless connection) so that signals can be input and output.

The processing circuit 11 is equivalent to the central part of the server 1 (e.g., a central processing unit (CPU)). The processing circuit 11 is an element that configures a computer of the server 1. The processing circuit 11 may be configured with various circuits. The processing circuit 11 loads a program that is stored in advance in the main memory 12 or the auxiliary storage device 13 into the main memory 12. The program is a program that causes the processing circuit 11 of the server 1 to implement each part of an operation/process to be described below. The processing circuit 11 executes various operations by executing the program loaded into the main memory 12.

The main memory 12 is equivalent to a main memory part of the server 1. The main memory 12 is an element that configures the computer of the server 1. The main memory 12 includes a non-volatile memory area and a volatile memory area. The main memory 12 stores an operating system or the program in the non-volatile memory area. The main memory 12 uses the volatile memory area as a work area where data is appropriately rewritten by the processing circuit 11. For example, the main memory 12 includes a read only memory (ROM) as the non-volatile memory area. For example, the main memory 12 includes a random access memory (RAM) as the volatile memory area. The main memory 12 may store one or more programs.

The auxiliary storage device 13 is equivalent to an auxiliary storage part of the server 1. The auxiliary storage device 13 is an element that configures the computer of the server 1. The auxiliary storage device 13 is an electric erasable programmable read-only memory (EEPROM) (registered trademark), a hard disc drive (HDD), a solid state drive (SSD), or the like. The auxiliary storage device 13 stores the above-mentioned programs, data used by the processing circuit 11 when performing various processes, and data generated by the processing in the processing circuit 11. The auxiliary storage device 13 stores the above-mentioned programs.

The auxiliary storage device 13 includes a user information storage area 130. The user information storage area 130 stores user information. The user information includes information associated with a user, such as user identification information, experience values, attribute information, location information, work history information, and an intimacy level. The user identification information is identification information for uniquely identifying a user. The user refers to a user who uses the workflow service. The user identification information is, for example, a user ID. The experience value indicates an experience value for each workflow. The attribute information is information regarding a user's attributes. The attribute information includes, for example, a department, team, and project the user is assigned. The location information is information regarding a location of the user (e.g., the location of the office the user works at, the name of an office, and the name of a branch office, etc.). The location information is not limited to the listed examples and may be any information that makes it possible to specify the user's location. The work history information includes information indicating a work history for each workflow. The work history includes information such as the date and time of work and a working time. The work history information includes information indicating the date last worked for each workflow.

The intimacy level indicates the degree of intimacy between users (e.g., how closely acquainted various users are). The intimacy level indicates the density of a relationship between users. The intimacy level is, for example, a value generated based on the quality or quantity of communication between a plurality of users. The communication between the users can include one-way communication and two-way communication. The communication indicates exchange of text or voice messages, and the like between user terminals (e.g., via e-mail, chat, or electronic conference applications such as Web conferences). For example, the intimacy level may be a value that is set based on a cumulative number of communications between users. The larger the cumulative number of communications between users is, the higher the intimacy level between the users may be set. The intimacy level may be a value that is set based on a cumulative time of communication between users. For example, the longer the cumulative time of communication between users, the higher the intimacy level between the users may be set. For example, an intimacy level between users who participate in the same electronic conference may be set to be high. The intimacy level may be generated based on the content of communication between the users, such as e-mail, chat, or electronic conference, attitude, and the like. The user information may be appropriately updated based on information acquired from the user terminal 2. The user information may be appropriately updated based on information acquired from the supporter terminal 3.

The auxiliary storage device 13 includes a workflow storage area 131. The workflow storage area 131 stores information regarding a workflow. The information regarding the workflow includes information such as a circulator, a circulation route, and authority. The circulator indicates a person who circulates the document data and the like generated for each workflow. The information regarding the circulator is information that makes it possible to identify the circulator. The circulator includes a checker, an approver, and the like. The circulation route is information indicating the order in which the circulator circulates the document data and the like. The authority is information indicating the authority of the worker or the circulator. The authority indicates operations that can be executed by the worker or the circulator. The operations that can be executed include, for example, generation, update, modification, approval, and return. The information regarding the workflow may include other information regarding the workflow. The information regarding the workflow may be set or updated by an administrator of the workflow service.

The auxiliary storage device 13 may store the work status of a workflow. The work status indicates information indicating a worker, input data, attached data, status, and the like. The worker is information that makes it possible to identify a user who performs work. The input data indicates data such as text of necessary items input by the worker, and data such as text edited by the worker. The attached data indicates data such as necessary documents. The attached data includes data uploaded to a workflow service. The status indicates the status of the work. The work status includes, for example, drafting, applied for, waiting for a check, waiting for approval, settlement completed, and the like. The work status can be updated based on the operation of the worker.

The communication interface 14 includes various interfaces that connect the server 1 to other devices via the network in accordance with a predetermined communication protocol so that the server 1 can communicate with the other devices.

A hardware configuration of the server 1 is not limited to the above configuration. The server 1 allows the above-mentioned components to be omitted or changed and new components to be added as appropriate.

Parts implemented by the processing circuit 11 mentioned above will be described in further detail below. The processing circuit 11 implements an acquisition unit 110, a determination unit 111, an inquiry processing unit 112, an update unit 113, and a communication processing unit 114. Each part implemented in the processing circuit 11 can also be referred to as functions. Each part implemented by the processing circuit 11 can also be referred to as being implemented by a control unit that includes the processing circuit 11 and the main memory 12. The processing circuit 11 is an example of a processing circuit.

The acquisition unit 110 acquires the user information from the auxiliary storage device 13. The acquisition unit 110 may acquire the user information from the user terminal 2 via the communication interface 14. In the following description, “acquire” and “receive” may be used interchangeably.

The determination unit 111 performs a determination process related to a skill level of a user. The determination unit 111 determines a user's skill level based on the user information. The determination unit 111 determines the user's skill level based on an experience value. Determining the skill level includes determining whether the user is a skilled person or an unskilled person. The skilled person indicates that the identified person has sufficient experience, knowledge, or skill to perform work on a workflow. The unskilled person indicates that the identified person does not have sufficient experience, knowledge, or skill to perform work on a workflow. Determining that a person is unskilled may indicate that the identified person would need support from a skilled person in order to work on a workflow. The unskilled person indicates a worker who is a target of an inquiry service. A user being a skilled person indicates that a skill level is “skilled.” A user being an unskilled person indicates that a skill level is “unskilled.” The skill level being “skilled”, for example, indicates that the experience value is equal to or greater than a first threshold value. The skill level being “unskilled” indicates that the experience value is less than the first threshold value. The first threshold value can be freely set by an administrator or the like.

The determination unit 111 may determine a user's skill level based on work history information. When an elapsed time since the date last worked is equal to or greater than a predetermined value, the determination unit 111 may determine the skill level to be “unskilled”. The predetermined value may be, for example, 3 months or 6 months. The predetermined value may be set freely by an administrator or the like.

The inquiry processing unit 112 performs inquiry processing for inquiring a supporter. The inquiry processing includes processing for extracting/identifying a support candidate. The inquiry processing unit 112 extracts/identifies the support candidate based on user information of other users different from the user of the user terminal 2. The support candidate indicates, for example, a skilled person having an experience value equal to or greater than a second threshold value. The second threshold value can be set freely by an administrator or the like. The second threshold value may be the same as the first threshold value, or may be a different value. The inquiry processing unit 112 determines a priority level of the support candidate. The priority level indicates a priority or a priority order. The inquiry processing unit 112 determines the priority level of the support candidate based on information regarding the priority level.

The information regarding the priority level is information based on user information of the support candidate. The information regarding the priority level may be information based on the user information of the worker and the user information of the support candidate. The information regarding the priority level includes information indicating a relationship between the worker and the support candidate. The information indicating the relationship between the worker and the support candidate may include at least one of attribute information, location information, and an intimacy level between the worker and the support candidate. The information indicating the relationship between the worker and the support candidate may be a priority score that is a numerical value of information such as attribute information, location information, and an intimacy level between the worker and the support candidate. The priority score may be set to be higher, for example, the more similar the attributes are. Specifically, when the worker and the support candidate belong to the same department, the priority score may be set to be high. When the worker and the support candidate belong to different departments, the priority score may be set to be low. The priority score may be set to be high, for example, as the location indicated in the location information is closer. Specifically, when the worker and the support candidate belong to the same department, the priority score may be set to be high. When the worker and the support candidate belong to different departments, the priority score may be set to be low. For example, the priority score may be set based on the intimacy level between the worker and the support candidate. Specifically, when the intimacy level between the worker and the support candidate is high, the priority score may be set to be high. When the intimacy level between the worker and the support candidate is low, the priority score may be set to be low. A method of calculating the priority score may be set by an administrator or the like.

The information regarding the priority level may include work history information. For example, the shorter the elapsed time since the date last worked, the higher the priority score may be set. The information regarding the priority level is not limited to the above and may be any information that can be converted into a numerical value as a priority score indicating a relationship between the worker and the support candidate.

The update unit 113 updates a user's experience value. The experience value may be updated based on a work history. The experience value may be updated based on a support history. For example, the update unit 113 may add a predetermined value to the experience value based on the completion of work by the user. The update unit 113 may add a different value to the experience value depending on the working time. For example, the update unit 113 may add additional points to the experience value when the working time by the worker is shorter than the average working time (e.g., indicating that the user is more efficient than other users). The update unit 113 may add a predetermined value to the experience value based on the completion of the supporter's support. The update unit 113 may add a different value to the experience value depending on a support time. For example, the update unit 113 may add additional points to the experience value when the support time of the supporter is longer than an average working time. The update unit 113 may add a different value to the experience value depending on a working time of a person to be supported. For example, the update unit 113 may add additional points to the experience value when the working time of the person to be supported is shorter than the average working time.

The communication processing unit 114 processes communication between the server 1 and other devices via the network. The communication processing unit 114 outputs various requests or various instructions to the user terminal 2 and the supporter terminal 3 via the communication interface 14. The communication processing unit 114 acquires various requests or various instructions from the user terminal 2 and the supporter terminal 3 via the communication interface 14.

### Operation Example

A process performed by the work support system 100 will be described in more detail below. In the following description that focuses on the server 1, the server I used interchangeably with processing circuit 11. Similarly, in the following description that focuses on the user terminal 2, the user terminal 2 may be read as a processing circuit of the user terminal 2. In the following description that focuses on the supporter terminal 3, the supporter terminal 3 may be read as a processing circuit of the supporter terminal 3.

A processing procedure to be described below is merely an example, and each process may be changed. In addition, steps may be omitted, replaced, or added to the processing procedure to be described below as appropriate depending on the embodiment. In the following processing, it is assumed that the user (drafter) of the user terminal 2 uses a workflow service provided by the server 1. It is assumed that the user of the user terminal 2 selects a workflow to be worked on and perform drafting work. The workflow to be worked on is also referred to as a target workflow.

The following processing will be described using an example in which the user of the user terminal 2 submits an expense application. An expense application workflow includes drafting work performed by a drafter, work checking performed by a checker, and approval work performed by an approver. The document data generated by the drafter is circulated to the checker. The document data confirmed by the checker is then confirmed by the approver. In this example, a worker of the succeeding order after the drafter is the checker, and a worker of the succeeding order after the checker is the approver.

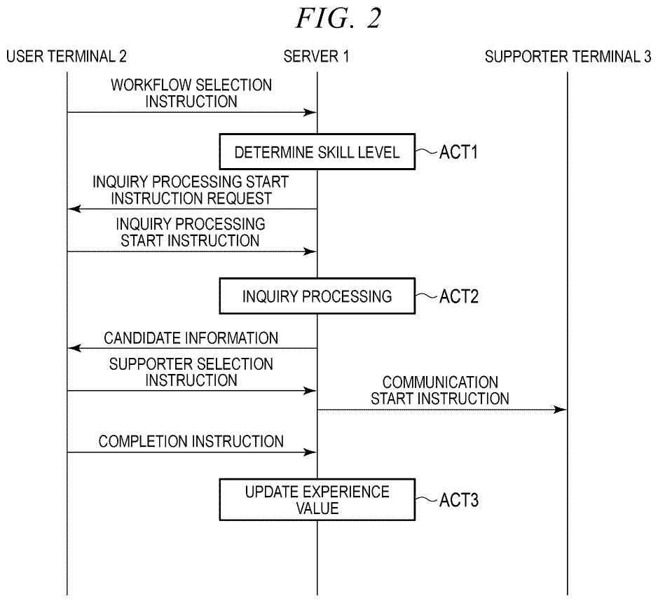

FIG. 2 is a sequence diagram showing an example of a procedure of information processing performed by the work support system 100 according to the embodiment.

The processing circuit 11 of the server 1 acquires a workflow selection instruction from the user terminal 2. The workflow selection instruction is an instruction to select a target workflow from among a plurality of workflows. In this example, the target workflow is “expense application”. For example, the user of the user terminal 2 performs an operation to select the target workflow from a menu image displayed on a display device or the like (e.g., a user device such as a PC, laptop, mobile phone, tablet, etc.). The menu image includes, for example, a selection button that makes it possible to select the target workflow from among the plurality of workflows. The menu image includes a plurality of user selectable workflow options such as a travel expense application, an expense application, a facility use application, and/or a report generation option. The selection button is an operator that makes it possible to input a selection instruction for a target workflow. The selection instruction is also referred to as an instruction to start a workflow. The user of the user terminal 2 may select the selection button by a touch input or the like in accordance with the menu image. The selection instruction may include identification information that makes it possible to identify the user of the user terminal 2 (e.g., a user ID number, name, location, etc.).

The processing circuit 11 determines a user's skill level (ACT1). ACTI may be processing performed by the determination unit 111. In ACT1, for example, the processing circuit 11 determines the user's skill level based on user information acquired from the user information storage area 130. In this example, it is assumed that the processing circuit 11 determines that the user's skill level is “unskilled”.

The processing circuit 11 outputs an inquiry processing start instruction request to the user terminal 2. The inquiry processing start instruction request may be output by the communication processing unit 114. The inquiry processing start instruction request is, for example, a message requesting whether to start inquiry processing. The inquiry processing start instruction request includes a message such as “Do you want to use an inquiry service?” The inquiry processing start instruction request may be at least one of text data, image data, sound data, and video data. The user terminal 2 may display an inquiry processing selection image including a selection button making it possible to select whether to start inquiry processing on a display device of the user terminal 2. The selection button is, for example, an operator that makes it possible to input an instruction regarding whether to start inquiry processing. In this case, the user may select the selection button by a touch input or the like to instruct whether to start inquiry processing. In this example, it is assumed that the user selects the selection button at the start of the inquiry processing. The user terminal 2 outputs an inquiry processing start instruction to the server 1 based on the user's operation of the selection button or the like.

The processing circuit 11 performs inquiry processing based on the inquiry processing start instruction (ACT2). ACT2 may be processing performed by the inquiry processing unit 112. In ACT2, for example, the processing circuit 11 extracts support candidates based on user information of other users. The other users indicate, for example, users who have rights to access a target workflow. The processing circuit 11 determines the priority levels of the support candidates. The processing circuit 11 outputs information regarding the extracted support candidates to the user terminal 2. The information regarding the support candidates may be output by the communication processing unit 114. The information regarding the support candidates may include information indicating the priority levels of the support candidates.

The user of the user terminal 2 selects a supporter from among the support candidates. The user of the user terminal 2 may select the supporter in accordance with a supporter selection request message. The supporter selection request message is, for example, a message requesting an instruction to select a supporter from among the support candidates. The supporter selection request message includes, for example, a message such as “Please select a supporter (consultant)”. The supporter selection request message may be at least one of text data, image data, sound data, and video data. The user terminal 2 may display a supporter selection image including a selection button, which makes it possible to select a supporter, on the display device. The selection button is, for example, an operator that makes it possible to input a supporter selection instruction. In this case, the user may select the selection button by a touch input or the like to instruct the selection of a supporter. The user terminal 2 outputs the supporter selection instruction to the server 1 based on the user's operation of the selection button or the like.

The processing circuit 11 outputs a communication start instruction to the supporter terminal 3 of the selected supporter based on the supporter selection instruction. For example, the processing circuit 11 may output the communication start instruction to the supporter terminal 3 based on a communication unit provided by a workflow service. The processing circuit 11 may output the communication start instruction to the supporter terminal 3 via an application different from the workflow service. For example, the processing circuit 11 may start a mail function or a chat function provided by the workflow service and output a notice to the supporter terminal 3. The processing circuit 11 may generate an e-mail including a text message and start a mailer or the like to transmit the e-mail to a mail address of the supporter terminal 3. The processing circuit 11 may start a chat application and transmit a chat message including a text message to the account of the supporter terminal 3.

The user of the user terminal 2 receives support from the supporter through communication with the supporter terminal 3. For example, the user of the user terminal 2 may ask the supporter a question about an expense application. The user of the user terminal 2 may ask the supporter, for example, how to upload documents required for the expense application. The user of the user terminal 2 completes the work with the support from the supporter. The user terminal 2 outputs a work completion instruction to the server 1. The user of the user terminal 2 outputs the completion instruction to server 1, for example, by selecting a completion button or the like included in an input image displayed on the display device of the user terminal 2. The input image is an image for a drafter to perform work. The completion button is an operator that makes it possible to input the work completion instruction. The completion instruction may include identification information that makes it possible to identify the user of the user terminal 2.

The processing circuit 11 circulates document data to a worker of the succeeding order based on the completion instruction. For example, the processing circuit 11 specifies the worker of the succeeding order in accordance with a circulation route of a target workflow. The processing circuit 11 may notify the worker of the succeeding order. The worker of the succeeding order may access a workflow service and start working based on a notification.

The processing circuit 11 updates an experience value (ACT3). ACT3 may be processing performed by the update unit 113. In ACT3, for example, the processing circuit 11 updates the user's experience value based on the user's completion of the work. For example, the processing circuit 11 adds a predetermined value to the experience value associated with the workflow for which the work is completed. The processing circuit 11 may add additional points to the experience value when the user's working time is shorter than an average working time of the target workflow.

The processing circuit 11 may update an experience value of a supporter. For example, the processing circuit 11 adds a predetermined value to the experience value associated with the workflow supported by the supporter. The processing circuit 11 may add additional points to the experience value when the supporter's support time is longer than an average working time. The processing circuit 11 may add additional points to the experience value when a working time of a person to be supported is shorter than the average working time.

The processing circuit 11 may update the user information stored in the user information storage area 130 based on the update of the experience value. Additionally, when the user's skill level is determined to be “skilled” in ACT1, the processing circuit 11 may omit inquiry processing. In this case, the processing circuit 11 circulates the document data to the worker of the succeeding order based on the user's work completion instruction. The processing circuit 11 updates the user's experience value.

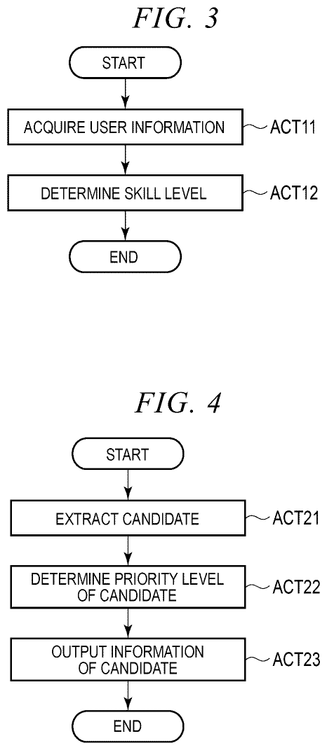

A skill level determination process will now be described. FIG. 3 is a flowchart showing an example of a procedure of information processing related to skill level determination by the server 1 according to the embodiment.

The processing circuit 11 acquires user information of the user of the user terminal 2 stored in the user information storage area 130 (ACT11). ACT11 may be processing performed by the acquisition unit 110. In ACT11, for example, the processing circuit 11 acquires the user information from the user information storage area 130 based on the user identification information of the user of the user terminal 2.

The processing circuit 11 determines the user's skill level based on the user information (ACT12). ACT12 may be processing performed by the determination unit 111. In ACT12, for example, the processing circuit 11 acquires the user's experience value associated with the target workflow. The processing circuit 11 determines the user's skill level based on the user's experience value. As a specific example, the processing circuit 11 compares the user's experience value with a first threshold value. The first threshold value may be, for example, an average value of experience values of a plurality of users related to the target workflow. When the experience value of the user is less than the first threshold value, the processing circuit 11 determines that the user's skill level is “unskilled”. The skill level of “unskilled” corresponds to being an unskilled person. When the experience value of the user is equal to or greater than the first threshold value, the processing circuit 11 determines that the user's skill level is “skilled”. The skill level of “skilled” corresponds to being a skilled person.

The processing circuit 11 may determine the skill level based on the user's work history information. For example, the processing circuit 11 acquires the user's work history information associated with the target workflow. When the elapsed time since the date last worked is equal to or greater than a predetermined value, the processing circuit 11 determines that the user's skill level is “unskilled”.

The processing circuit 11 may determine the skill level based on the user's experience value and the user's work history information. For example, the processing circuit 11 may determine the user's skill level to be “unskilled” when the elapsed time since the date last worked is equal to or greater than the predetermined value, even when the skill level of the user is determined to be “skilled” based on the user's experience value. The processing circuit 11 may determine the user's skill level to be “skilled” when the elapsed time since the date last worked is less than the predetermined value, even when the skill level of the user is determined to be “unskilled” based on the user's experience value. The processing circuit 11 may determine the user's skill level to be “skilled” when the elapsed time since the date last worked is less than the predetermined value even when the user's skill level is determined to be “skilled” based on the user's experience value. The processing circuit 11 may determine the user's skill level to be “unskilled” when the elapsed time since the date last worked is equal to or greater than the predetermined value, even when the user's skill level is determined to be “unskilled” based on the user's experience value.

The processing circuit 11 may further determine the skill level based only on the work history information for users whose skill level is determined to be “skilled” based on the user's experience value. The processing circuit 11 may change the user's skill level from “skilled” to “unskilled” when the elapsed time since the date last worked is equal to or greater than the predetermined value. The processing circuit 11 may determine the user's skill level to be “skilled” when the elapsed time since the date last worked is less than the predetermined value.

According to this example, the server 1 can acquire the user's experience value and determine the user's skill level based on the experience value. For this reason, the server 1 can appropriately determine which users need support for each workflow. The server 1 can also acquire the user's work history information and determine the skill level based on the work history information. For example, if a long time has passed since the user last worked on a workflow, the methods, rules, and the like of the current workflow may have changed since the user last worked, or the user may have forgotten them. In this way, the server 1 can determine that a user who has a high experience value, but has a long elapsed time since the date last worked is an unskilled person. For this reason, the server I can more appropriately determine which users need support.

### Inquiry Processing

FIG. 4 is a flowchart showing an example of a procedure of information processing related to inquiry processing performed by the server 1 according to the embodiment.

The processing circuit 11 extracts support candidates based on user information (ACT21). ACT21 may be processing performed by the inquiry processing unit 112. In ACT21, for example, the processing circuit 11 acquires user information stored in the user information storage area 130. The processing circuit 11 acquires user information of all users who have rights to access a target workflow. The processing circuit 11 acquires an experience value related to the target workflow. The processing circuit 11 extracts users whose experience values are equal to or greater than a second threshold value as support candidates. The support candidate may be the same as a skilled person. The support candidate may be a user whose experience value is equal to or greater than the second threshold value among the skilled people. The second threshold value may be, for example, a value greater than the first threshold value. The second threshold value may be the same as the first threshold value. The processing circuit 11 may extract the support candidate based on the work history information. For example, the processing circuit 11 may extract as the support candidate a user whose experience value is equal to or greater than the second threshold value and whose elapsed time since the date last worked is less than a predetermined value.

The processing circuit 11 determines the priority level of the support candidate (ACT22). ACT22 may be processing performed by the inquiry processing unit 112. In ACT22, for example, the processing circuit 11 determines the priority level of the support candidate based on the user information of the support candidate. The processing circuit 11 determines the priority level of the support candidate based on information regarding the priority level. The processing circuit 11 may determine the priority level of the support candidate based on a priority score.

The processing circuit 11 may determine the priority level of the support candidate based on information regarding a plurality of priority levels. The processing circuit 11 may determine the priority level of the support candidate based on weighting that is set on information regarding priority levels. The weighting on the information regarding priority levels may be set by an administrator or the like. For example, the processing circuit 11 may weight a priority score related to an intimacy level, calculate a priority score for information regarding a plurality of priority levels, and determine the priority levels of support candidates.

The information regarding priority levels may be set by an administrator or the like. The information regarding priority levels may be set differently for each workflow. A method of calculating the priority score may be different for each workflow. The settings of weighting may be different for each workflow.

The processing circuit 11 may determine a priority level of a support candidate based on information in an organization. The information in the organization includes, for example, absence information of a user. The absence information includes information regarding taking a vacation, information regarding going-out, information regarding working from home, and the like. The absence information may include information regarding a substitute when a user is absent. The processing circuit 11 may set a low priority level when a support candidate is absent. The information in the organization is not limited to the absence information. The information in the organization may include information obtained by a communication tool such as a social networking service (SNS) in the organization. The information in the organization may be, for example, information that can be updated at any time by a person belonging to the organization. According to this example, the processing circuit 11 can use the information regarding the support candidate that is updated at any time, and thus can determine a more appropriate priority level for the support candidate.

The processing circuit 11 outputs the information regarding the support candidate to the user terminal 2 (ACT23). ACT23 may be processing performed by the communication processing unit 114. In ACT23, for example, the processing circuit 11 outputs information that makes it possible to identify the support candidate to the user terminal 2. The processing circuit 11 may output, to the user terminal 2, information regarding a plurality of support candidates. The processing circuit 11 may output information indicating the priority level of the support candidate to the user terminal 2. The processing circuit 11 may output, to the user terminal 2, only information regarding a support candidate with the highest priority level among the plurality of support candidates. The processing circuit 11 may output, to the user terminal 2, information regarding a predetermined number of support candidates among the plurality of support candidates in descending order of priority level.

According to this example, in response to determining that a user's skill level is unskilled, the server 1 can extract support candidates based on experience values of other users and output information regarding the support candidates to the user terminal 2. For this reason, the server 1 can extract users with a high experience value for a target workflow as support candidates. In this way, the server 1 identifies users who are suitable to provide support as support candidates who can appropriately support an unskilled person. The server 1 can also determine the priority levels of the support candidates based on user information of the support candidates. For example, the server 1 can determine the priority levels of the support candidates based on information indicating a relationship between a worker and a support candidate. When the attributes of the worker and the support candidate are the same, there is a high possibility that the worker and the support candidate have similar contents of work (e.g., may work on similar projects, similar types of work, etc.). In addition, when the intimacy level between the worker and the support candidate is high, there is a high possibility that the worker will be able to communicate with the support candidate easily. For this reason, the server 1 can set a high priority level for an appropriate support candidate for each worker. The server 1 provides support candidates who are easy to communicate with to the user of the user terminal 2, making it possible to generate an environment in which an unskilled person can easily receive support. The user of the user terminal 2 can select a supporter based on a priority level and the server 1 can inquire about an appropriate supporter for an unskilled person. In this manner, the server 1 can improve the work efficiency of the unskilled person.

### Other Embodiments

The above-mentioned embodiment is described using a workflow service as an example, but is not limited thereto. The above-mentioned embodiment can also be applied to services such as SNS where a plurality of users communicate with each other or share information. In this case, a workflow can be read as a topic. The server 1 provides an inquiry service for inquiring a supporter for each topic. A skilled person indicates a person who has sufficient experience, knowledge, or skill in a topic.

The information processing device may be implemented by a single device such as the server 1, or may be implemented by a plurality of devices with distributed functions. In the latter case, the information processing device includes the meaning of an information processing system configured with a plurality of devices.

The above-mentioned embodiment may be applied not only to a device but also to a method executed by the device. The above-mentioned embodiment may be applied to a program capable of causing a computer of a device to execute each function. The above-mentioned embodiment may be applied to a recording medium that stores the program. The above-mentioned embodiment may be applied not only to a system but also to a method executed by a plurality of elements included in the system.

A processing circuit includes one or more circuits that implement a plurality of processes by a plurality of functions. For example, the circuit is a processor, an application specific integrated circuit (ASIC), or a field-programmable gate array (FPGA), but is not limited thereto.

Each of one or more circuits that configure the processing circuit executes one or more of processes among the plurality of processes. When the processing circuit is configured with a single circuit, the single circuit executes all of the plurality of processes. When the processing circuit is configured with a plurality of circuits, each of the plurality of circuits executes some of the plurality of processes. Some of the plurality of processes may be one of the plurality of processes or two or more of the plurality of processes. When the processing circuit is configured with a plurality of circuits, the plurality of circuits may be included in one device or may be distributed to a plurality of devices.

The program may be transferred in a state of being stored in a device, or transferred in a state of not being stored in a device. In the latter case, the program may be transferred via a network, or transferred in a state of being recorded on a recording medium. The recording medium is a non-transitory tangible medium. The recording medium is a computer-readable medium. The recording medium may be a medium, such as a CD-ROM or a memory card, which is capable of storing a program and being readable by a computer, and the form of the recording medium does not matter.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In short, this invention is not limited to the above-mentioned embodiment as it is, and in the implementation stage, the components can be modified and embodied without departing from the gist of the invention. Furthermore, various inventions can be formed by appropriately combining a plurality of components disclosed in the above-mentioned embodiment. For example, some components may be deleted from all of the components shown in the embodiment. Furthermore, components from different embodiments may be appropriately combined.

### Supplementary Note

The above-mentioned embodiment may be expressed as follows.

(1) An information processing device including:
an acquisition unit configured to acquire an experience value of a user;
a determination unit configured to determine a skill level of the user based on the experience value;
an inquiry processing unit configured to extract support candidates based on experience values of other users when the skill level of the user is unskilled; and
a communication processing unit configured to output information regarding the support candidates.

(2) The information processing device according to (1), in which the experience value is an experience value for each workflow.

(3) The information processing device according to (1), in which
the acquisition unit acquires work history information of the user, and
the determination unit determines the skill level based on the work history information.

(4) The information processing device according to (1) in which
the inquiry processing unit determines a priority level of the support candidate based on user information of the support candidate, and
the communication processing unit outputs information indicating the priority level of the support candidate.

(5) An information processing method including:
acquiring an experience value of a user;
determining a skill level of the user based on the experience value;
extracting support candidates based on experience values of other users when the skill level of the user is unskilled; and
outputting information regarding the support candidates.

(6) An information processing system including:
an information processing terminal; and
an information processing device,
in which the information processing device includes
an acquisition unit that acquires an experience value of a user of the information processing terminal;
a determination unit that determines a skill level of the user based on the experience value;
an inquiry processing unit that extracts support candidates based on experience values of other users when the skill level of the user is unskilled; and
a communication processing unit that outputs information regarding the support candidates to the information processing terminal.

What is claimed is:

1. An information processing device configured to:
acquire an experience value of a user;
determine a skill level of the user based on the experience value, wherein the skill level of the user is either skilled or unskilled;
extract support candidates based on experience values of other users in response to determining that the skill level of the user is unskilled;
output information regarding the support candidates; and
cause a display device to display information regarding at least one of (a) the skill level of the user, or (b) the support candidates.

2. The information processing device of claim 1, wherein the experience value is the experience value for a workflow of a plurality of workflows.

3. The information processing device of claim 1, wherein the information processing device is further configured to:
determine a priority level of the support candidates based on user information associated with the support candidates; and
output information indicating the priority level of the support candidates.

4. The information processing device of claim 1, wherein the information processing device is further configured to:
acquire work history information associated with the user; and
determine the skill level based on the work history information.

5. The information processing device of claim 4, wherein the information processing device is further configured to:
update the experience value of a user based on changes to the work history information associated with the user;
output the updated experience value of the user; and
cause the display device to display information regarding the skill level of the user.

6. A method for processing workflow information comprising:
acquiring an experience value of a user;
determining a skill level of the user based on the experience value, wherein the skill level of the user is either skilled or unskilled;
extracting support candidates based on experience values of other users in response to determining that the skill level of the user is unskilled;
outputting information regarding the support candidates; and
causing a display device to display information regarding at least one of (a) the skill level of the user, or (b) the support candidates.

7. The method of claim 6, wherein the experience value is the experience value for a workflow of a plurality of workflows.

8. The method of claim 6, further comprising:
determining a priority level of the support candidates based on user information associated with the support candidates; and
outputting information indicating the priority level of the support candidates.

9. The method of claim 6, further comprising:
acquiring work history information associated with the user; and
determining the skill level based on the work history information.

10. The method of claim 9, further comprising:
updating the experience value of a user based on changes to the work history information associated with the user;
outputting the updated experience value of the user; and
causing the display device to display information regarding the skill level of the user.

11. An information processing system comprising:
A user terminal; and
an information processing device configured to:
acquire an experience value of a user from the user terminal;
determine a skill level of the user based on the experience value, wherein the skill level of the user is either skilled or unskilled;
extract support candidates based on experience values of other users in response to determining that the skill level of the user is unskilled; and
output information regarding the support candidates to the user terminal.

12. The information processing system of claim 11, wherein the experience value is an experience value for a workflow of a plurality of workflows.

13. The information processing system of claim 11, wherein the information processing device is further configured to:
determine a priority level of the support candidates based on user information associated with the support candidates; and
output information indicating the priority level of the support candidates.

14. The information processing system of claim 11, wherein the information processing device is further configured to:
acquire work history information associated with the user; and
determine the skill level based on the work history information.

15. The information processing system of claim 14, wherein the information processing device is further configured to:
update the experience value of a user based on changes to the work history information associated with the user; and
output the updated experience value of the user to the user terminal.
